(19) United States
(12) Patent Application Publication
(10) Pub. No.: US 2024/0246682 A1
(43) Pub. Date: Jul. 25, 2024

(54) Container For Flight Craft

(71) Applicant: Iwaya Giken Inc., Sapporo-shi, Hokkaido (JP)

(72) Inventor: Keisuke IWAYA, Sapporo-shi (JP)

(21) Appl. No.: 18/627,491

(22) Filed: Apr. 5, 2024

Related U.S. Application Data
(62) Division of application No. 17/695,996, filed on Mar. 16, 2022.

(30) Foreign Application Priority Data
Mar. 19, 2021 (JP) 2021-046076
Sep. 21, 2021 (JP) 2021-153606

(51) Int. Cl. B64D 13/08; B64B 1/22; G03B 17/55

(52) U.S. Cl. CPC B64D 13/08; B64B 1/22; G03B 17/55

(57) ABSTRACT

The present invention reduces a probability of condensation forming in a container for a flying object. Container 12 is a cabin of a gas balloon. Container 12 comprises Main Body 121 that is an airtight container filled with air and accommodating Crew Member H1, and Partition 122 that divides the space in Main Body 121 into Space S1 and Space S2. Partition 122 has one or more narrow Holes H. When the altitude of the flying object increases and Container 12 cools from the outside, air in Space S1 cools more slowly than the air in Space S2. A pressure difference between Space S1 and Space S2 is rapidly equalized by air flow through Holes H, but it takes a long time to equalize a temperature difference between Space S1 and Space S2. Therefore, a temperature in Space S1 becomes higher than a temperature in Space S2, and a temperature in Space S2 becomes higher than a temperature in the space outside Main Body 121. As a result, condensation is unlikely to form in Partition 122 and in the portion of Main Body 121 that forms Space S2.

### CROSS REFERENCE TO RELATED APPLICATIONS

This application is a divisional application of U.S. application Ser. No. 17/695,996, filed Mar. 16, 2022, which claims priority to Japanese Patent Application No. 2021-153606, filed Sep. 21, 2021, and Japanese Patent Application No. 2021-046076, filed Mar. 19, 2021. The entire disclosures of the above applications are expressly incorporated herein by reference.

### TECHNICAL FIELD

This invention relates to a container for a flying object such as a balloon and an airship.

### BACKGROUND ART

Known in the art are flying objects such as balloons and airships provided with cabins that act as containers for accommodating humans (crew members). By use of such flying objects humans can be transported through air.

Patent Document 1 discloses a flying object equipped with a cabin for accommodating a crew member. Patent Document 1 proposes a manned drone equipped with a main body that accommodates a crew member and is suspended for flight by one or more balloons.

### PRIOR ART DOCUMENT

### Patent Document

Patent Document 1: JP2020-97345A

### SUMMARY OF THE INVENTION

### Problem to be Solved by the Invention

The higher an altitude of a flying object from the ground, the lower an ambient temperature generally becomes. When a temperature of a cabin wall of the flying object becomes lower than that of air in the cabin, air in contact with the cabin wall cools and condensation may occur. Condensation is a phenomenon by which water vapor in air cools upon contact with a surface of an object, converts to water and adheres to the surface of the object.

If a part of the cabin wall is a window with a plate that transmits light, formation of condensation on the window impedes an ability of a crew member to see out of the cabin. Moreover, if condensation forms on the cabin wall, water from the condensation may flow and reach an object in the cabin that is susceptible to damage by water, such as an electronic device.

A flying object may also be equipped with an airtight container that houses a device such as a camera device. In such a container, as with the cabin mentioned above, if condensation forms on a wall of the container, water from the condensation may damage the device in the container.

If a container for a flying object contains a camera device, it is desirable that a wall of the container be provided with a light-transmitting window in an area corresponding to an angle of view of the camera device. When condensation forms on the window, an image captured by the camera device may be out of focus, or water droplets caused by condensation may appear in the captured image.

In view of the above circumstances, the present invention provides a means of reducing a probability of formation of condensation in a container for a flying object.

### Means for Solving the Problem

The present invention includes, as a first aspect, a container for a flying object comprising: a main body that is airtight and contains an object; and a partition that divides a space in the main body into a first space and a second space; wherein the partition has one or more holes that enable gas to flow between the first space and the second space.

The present invention includes, as a second aspect, a container for a flying object comprising: a main body that is airtight and contains an object; and a partition that divides a space in the main body into a first space and a second space; wherein the partition keeps the first space airtight, and the main body has one or more holes that enable gas to flow between the second space and a space outside the main body.

The present invention includes, as a third aspect, a container according to the first aspect or the second aspect, wherein at least a part of the main body and at least a part of the partition transmit light so that light can penetrate from outside the main body into the first space.

The present invention includes, as a fourth aspect, a container for a flying object comprising: an inner main body that contains an object; and an outer main body that is airtight and contains the inner main body; wherein the inner main body has one or more holes that enable gas to flow between a space in the inner main body and a space outside the inner main body.

The present invention includes, as a fifth aspect, a container for a flying object comprising: an inner main body that is airtight and contains an object; and an outer main body that contains the inner main body; wherein the outer main body has one or more holes that enable gas to flow between a space in the outer main body and a space outside the outer main body.

The present invention includes, as a sixth aspect, a container according to the fourth aspect or the fifth aspect, wherein at least a part of the inner main body and at least a part of the outer main body transmit light so that light can penetrate from outside the outer main body into a space in the inner main body.

The present invention includes, as a seventh aspect, a container according to any one of the first aspect, the second aspect, the fourth aspect, and the fifth aspect, wherein the object is a human.

### Effects of Invention

According to the present invention, a space is formed between the space containing the object and the space outside the container, with a difference in temperature between these spaces. As a result, condensation is unlikely to occur.

### BRIEF EXPLANATION OF THE DRAWINGS

FIG. 1 shows an overall configuration of a flying object according to a first exemplary embodiment of the present invention.

FIG. 2 shows a configuration of a container according to a first exemplary embodiment of the present invention.

FIG. 3 shows a configuration of a container according to a second exemplary embodiment of the present invention.

FIG. 4 shows a configuration of a container according to a third exemplary embodiment of the present invention.

FIG. 5 shows a configuration of a container according to a fourth exemplary embodiment of the present invention.

FIG. 6 shows a configuration of a container according to a modification of the first exemplary embodiment of the present invention.

### MODES FOR CARRYING OUT THE INVENTION

### First Exemplary Embodiment

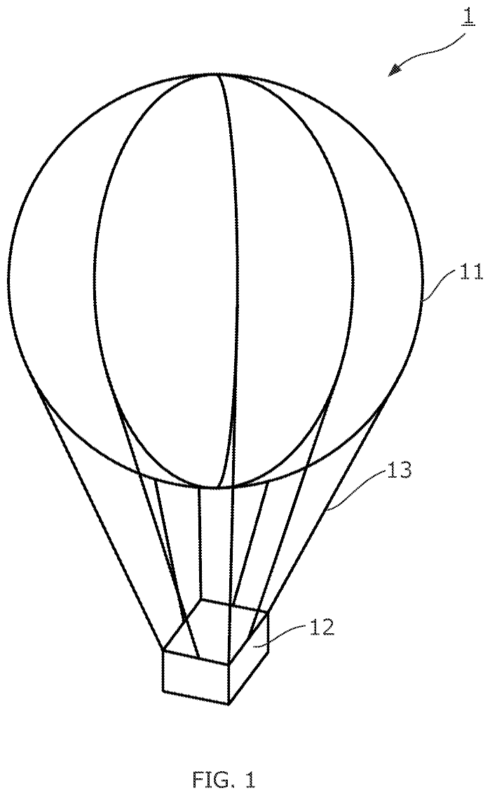

FIG. 1 shows an overall configuration of Flying Object 1 according to an exemplary embodiment of the present invention. Flying object 1 comprises Envelope 11 that contains a lighter-than-air gas such as helium, and Container 12 that is suspended from Envelope 11 via Suspension Ropes 13 and moves in flight with Envelope 11. One end of each Suspension Rope 13 is connected to Envelope 11 and the other end of each Suspension Rope 13 is connected to Container 12.

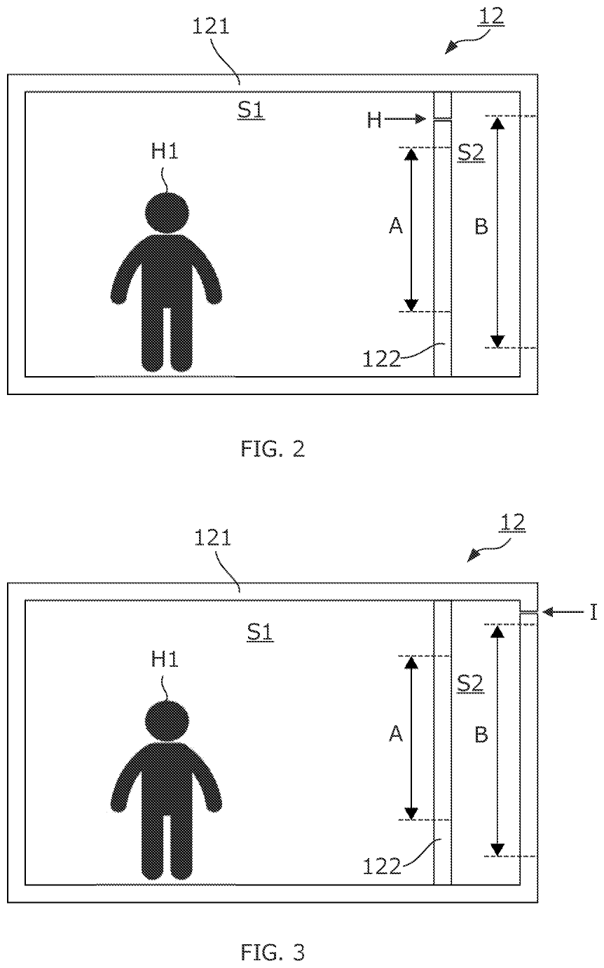

FIG. 2 shows a configuration of Container 12. Container 12 has Main Body 121 that is a hollow box that contains an object to be transported by Flying Object 1 such as Crew Member H1, and Partition 122 that divides the space in Main Body 121 into Space S1 (an example of a first space) and Space S2 (an example of a second space).

Space S1 is a space that contains Crew Member H1 and other objects. Space S1 is filled with air containing sufficient oxygen to enable Crew Member H1 to breathe.

At least a part of Partition 122 transmits light. In the example in FIG. 2, the portion of Range A of Partition 122 is made of a light-transmitting material such as transparent polycarbonate and acrylic resin. Partition 122, except for the portion of Range A is made of, for example, a fiber-reinforced plastic, a plastic other than a fiber-reinforced plastic, a lightweight metal such as aluminum, etc.

At least a part of the portion of Main Body 121 that forms Space S2 also transmits light. In the example shown in FIG. 2, the portion of Range B of Main Body 121 is made of a light-transmitting material such as transparent polycarbonate or an acrylic resin. Main Body 121, except for the portion of Range B is made of, for example, a fiber-reinforced plastic, a plastic other than a fiber-reinforced plastic, a lightweight metal such as aluminum, etc.

As described above, the portion of Range A of Partition 122 and the portion of Range B of Main Body 121 transmit light, which enables Crew Member H1 in Space S1 to see outside of Container 12 by light transmitted from outside Container 12 to Space S1.

Partition 122 has one or more Holes H. Each Hole H is narrow so as to enable a gradual gas flow between Space S1 and Space S2. Each Hole H enables gas to flow between Space S1 and Space S2 such that if a difference occurs between the temperature of the gas in Space S1 and the temperature of the gas in Space S2, a pressure difference caused by the temperature difference is rapidly equalized. Also, each Hole H is not so wide as to enable gas convection between Space S1 and Space S2. Therefore, it takes several minutes or several tens of minutes for a difference between a temperature of the gas in Space S1 and a temperature of the gas in Space S2 to be resolved.

In general, the higher an altitude of Flying Object 1 from the ground, the thinner and the colder the air outside Container 12 becomes. If Main Body 121 rapidly cools from the outside when Flying Object 1 ascends, condensation in Main Body 121 readily forms. Condensation is a phenomenon by which water vapor in air cools upon contact with a surface of an object, converts to water and adheres to the surface of the object.

However, a volume of gas in Space S1 relative to an area of Main Body 121 that the gas in Space S1 contacts is larger than a volume of gas in Space S2 relative to an area of Main Body 121 that the gas in Space S2 contacts. Therefore, a speed at which a temperature of the gas in Space S1 is cooled by Main Body 121 is slower than a speed at which a temperature of the gas in Space S2 is cooled by Main Body 121. As described above, gas flow by convection does not occur between Space S1 and Space S2.

Under the above-described conditions, the temperature in Space S1 becomes higher than the temperature in Space S2, and the temperature in Space S2 becomes higher than the temperature in the space outside Main Body 121. Therefore, both the difference in temperature between Space S1 and Space S2 and the difference in temperature between Space S2 and the space outside Main Body 121 are smaller than the difference between the temperature of the space in Main Body 121 and the temperature of the space outside Main Body 121 that would occur if Partition 122 was not provided.

For the above-described reasons, compared to a probability of condensation forming in Main Body 121 if Partition 122 was not provided, a probability of condensation forming in Partition 122 and a probability of condensation forming in the portion of Main Body 121 that forms Space S2 according to this embodiment are low.

As mentioned, it takes a long time to equalize a temperature difference between Space S1 and Space S2, but the pressure difference between Space S1 and Space S2 is rapidly equalized. Consequently, Partition 122 is not subject to deformation or other damage that may otherwise be caused by forces exerted as a result of a difference in air pressure between Space S1 and Space S2.

As described above, according to Container 12, condensation is unlikely to form at least in Partition 122 and in the portion of Main Body 121 that forms Space S2.

### Second Exemplary Embodiment

Container 12 according to a second embodiment of the present invention is described below. Container 12 according to the second embodiment, as with Container 12 according to the first embodiment, is a container for Flying Object 1 (see FIG. 1) that is suspended from Envelope 11 via Suspension Ropes 13 for flight. Container 12 according to the second embodiment differs from Container 12 according to the first embodiment in the following points:
(1) Partition 122 of Container 12 according to the second embodiment unlike Container 12 according to the first embodiment is not provided with Holes H.
(2) Main Body 121 of Container 12 according to the second embodiment has one or more Holes I in the portion that forms Space S2, similar to Holes H that Partition 122 of Container 12 according to the first embodiment has.

FIG. 3 shows the configuration of Container 12 according to this embodiment.

In Container 12 according to this embodiment, when a temperature in the space outside Main Body 121 rapidly drops as the fight altitude of Flying Object 1 increases, a pressure difference between Space S2 and a space outside Main Body 121 is rapidly equalized, while the temperature difference between Space S2 and the space outside Main Body 121 takes time to equalize. As a result, as in the case of Container 12 according to the first embodiment, the temperature in Space S1 becomes higher than the temperature in Space S2, and the temperature in Space S2 becomes higher than the temperature in the space outside Main Body 121.

Therefore, for reasons similar to those explained in the first embodiment, compared to a probability of condensation forming in Main Body 121 (without Hole I) if there were no Partition 122, a probability of condensation forming in Partition 122 and a probability of condensation forming in the portion of Main Body 121 that forms Space S2 in this embodiment are low.

As mentioned, it takes a long time to resolve a temperature difference between Space S2 and the space outside Main Body 121, but a pressure difference between Space S2 and the space outside Main Body 121 is rapidly equalized. Consequently, the portion of Main Body 121 that forms Space S2 will not be deformed or damaged by forces that would otherwise be caused by forces exerted due to a difference in air pressure between Space S2 and the space outside Main Body 121.

As described above, according to Container 12 of this embodiment, condensation is unlikely to form at least in Partition 122 and in the portion of Main Body 121 that forms Space S2.

### Third Exemplary Embodiment

Container 22 according to a third embodiment of the present invention is described below. Container 22 according to the third embodiment, like Container 12 according to the first embodiment, is a container for Flying Object 1 (see FIG. 1) that is suspended from Envelope 11 via Suspension Ropes 13 for flight.

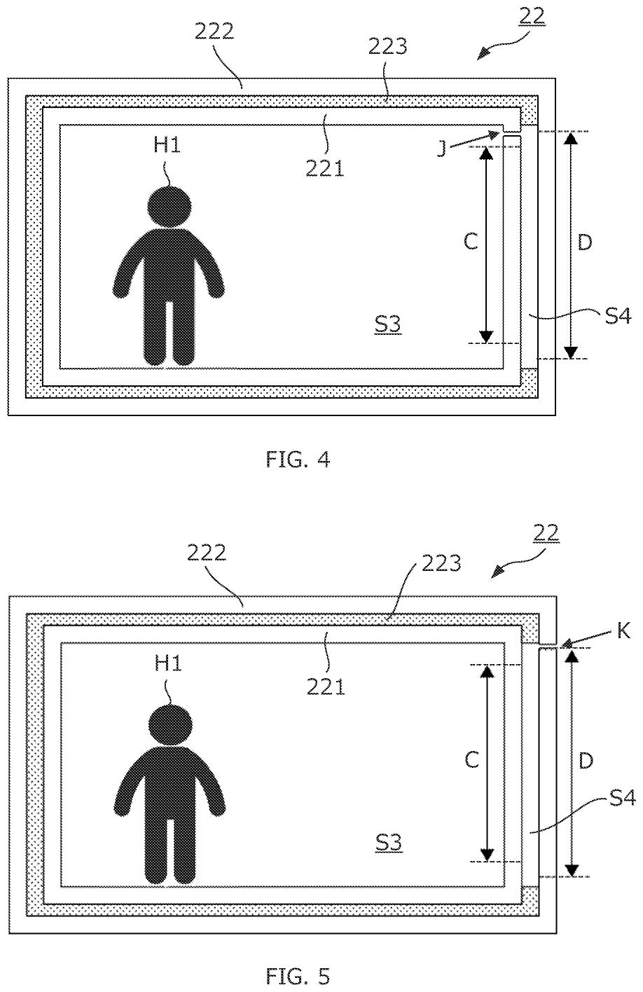

FIG. 4 shows the configuration of Container 22. Container 22 has Inner Main Body 221 that contains an object to be transported by Flying Object 1 such as Crew Member H1, Outer Main Body 222 that is airtight and contains Inner Main Body 221, and Heat Insulating Material 223 provided in a part of a space between Inner Main Body 221 and Outer Main Body 222. Container 22 need not have Heat Insulating Material 223.

The space in Inner Main Body 221 is hereafter referred to as Space S3, and the space between Inner Main Body 221 and Outer Main Body 222 is hereafter referred to as Space S4.

Space S3 and Space S4 are filled with air containing sufficient oxygen to allow Crew Member H1 to breathe.

At least a part of Inner Main Body 221 transmits light. In the example in FIG. 4, the portion of Range C of Inner Main Body 221 is made of a light-transmitting material such as transparent polycarbonate and acrylic resin. Inner Main Body 221 except for the portion of Range C is made of, for example, a fiber-reinforced plastic, a plastic other than a fiber-reinforced plastic, a lightweight metal such as aluminum, etc.

At least a part of Outer Main Body 222 transmits light. In the example shown in FIG. 4, the portion of Range D of Outer Main Body 222 is made of a light-transmitting material such as transparent polycarbonate and acrylic resin. Outer Main Body 222 except for the portion of Range D is made of, for example, a fiber-reinforced plastic, a plastic other than a fiber-reinforced plastic, a lightweight metal such as aluminum, etc.

As described above, the portion of Range C of Inner Main Body 221 and the portion of Range D of Outer Main Body 222 transmit light, which enables Crew Member H1 in Inner Main Body 221 to see outside of Container 22 by light transmitted from outside Outer Main Body 222 to the space in Inner Main Body 221.

Inner Main Body 221 has one or more Holes J. Each Hole J is narrow, and enables a gradual gas flow between Space S3 and Space S4. Each Hole J enables gas to flow between Space S3 and Space S4 so that if a difference occurs between the temperature of the gas in Space S3 and the temperature of the gas in Space S4, a pressure difference caused by the temperature difference is rapidly equalized. On the other hand, each Hole J is not so wide as to create gas convection between Space S3 and Space S4. Therefore, it takes several minutes or several tens of minutes for a difference between the temperature of the gas in Space S3 and the temperature of the gas in Space S4 to equalize.

Therefore, if the altitude of Flying Object 1 increases and Container 22 is cooled from the outside, a temperature in Space S3 becomes higher than the temperature in Space S4, and the temperature in Space S4 becomes higher than the temperature in the space outside Outer Main Body 222. Therefore, each of a difference in temperature between Space S3 and Space S4 and a difference in temperature between Space S4 and the space outside Outer Main Body 222 is smaller than a difference between the temperature of the space in Outer Main Body 222 and the temperature of the space outside Outer Main Body 222 that would occur if there were no Inner Main Body 221.

For the above-described reasons, compared to the probability of condensation forming in Outer Main Body 222 if there were no Inner Main Body 221, the probability of condensation forming in Inner Main Body 221 and the probability of condensation forming in Outer Main Body 222 are low.

As mentioned, it takes a long time to equalize a temperature difference between Space S3 and Space S4, but a pressure difference between Space S3 and Space S4 is rapidly equalized. Therefore, Inner Main Body 221 is not subject to deformation or other damage that would otherwise be caused by forces exerted due to a difference in air pressure between Space S3 and Space S4.

As described above, according to Container 22, condensation is unlikely to form in Inner Main Body 221 and in Outer Main Body 222.

### Fourth Exemplary Embodiment

Container 22 according to a fourth embodiment of the present invention is described below. Container 22 according to the fourth embodiment, like Container 12 according to the first embodiment, is a container for Flying Object 1 (see FIG. 1) that is suspended from Envelope 11 via Suspension Ropes 13 for flight. Container 22 according to the fourth embodiment differs from Container 22 according to the third embodiment in the following points:
(1) Inner Main Body 221 of Container 22 according to the fourth embodiment does not have Holes J that Inner Main Body 221 of Container 22 according to the third embodiment has.
(2) Outer Main Body 222 of Container 22 according to the fourth embodiment has one or more Holes K, similar to Holes J that Inner Main Body 221 of Container 22 according to the third embodiment has.
(3) Space S4 in the fourth embodiment is not necessarily filled with air containing oxygen.

FIG. 5 shows a configuration of Container 22 according to this embodiment.

In Container 22 according to this embodiment, when the temperature in the space outside Outer Main Body 222 drops rapidly as the flight altitude of Flying Object 1 increases, a pressure difference between Space S4 and the space outside Outer Main Body 222 is quickly resolved, while the temperature difference between Space S4 and the space outside Outer Main Body 222 takes time to equalize. As a result, as in the case of Container 22 according to the third embodiment, a temperature in Space S3 becomes higher than a temperature in Space S4, and a temperature in Space S4 becomes higher than a temperature in the space outside Outer Main Body 222.

Therefore, for reasons similar to those in the third embodiment, compared to the probability of condensation forming in Outer Main Body 222 (without Hole K) if there were no Inner Main Body 221, a probability of condensation forming in Inner Main Body 221 and a probability of condensation forming in Outer Main Body 222 are low.

As mentioned, it takes a long time to equalize a temperature difference between Space S4 and the space outside Outer Main Body 222, but the pressure difference between Space S4 and the space outside Outer Main Body 222 is rapidly equalized. Therefore, Outer Main Body 222 is not subject to deformation or other damage that would otherwise be caused by forces exerted due to a difference in air pressure between Space S4 and the space outside Outer Main Body 222.

As described above, according to Container 22 of this embodiment, condensation is unlikely to form in Inner Main Body 221 and in Outer Main Body 222.

### MODIFICATIONS

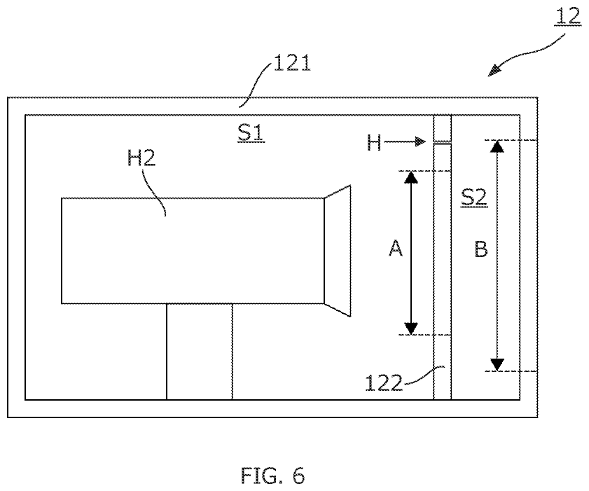

The above-described Flying Object 1 is of an exemplary embodiment of the present invention, and may be modified in various ways. Following are examples of modifications of the above-described embodiment. Two or more of the above-described embodiments and the following modifications may be combined.
(1) In the embodiments described above, Main Body 121 of Container 12 according to the first or second embodiment, and Inner Main Body 221 of Container 22 according to the third or fourth embodiment are a cabin that accommodates a human. Main Body 121 of Container 12 or Inner Main Body 221 of Container 22 need not accommodate a human. FIG. 6 shows Main Body 121 of Container 12 according to the first embodiment that contains Camera Device H2.
(2) In the above-described embodiments, Flying Object 1 is a gas balloon, but the type of Flying Object 1 is not limited to a gas balloon. Flying Object 1 may be any other type of flying object such as a thermal balloon and an airship.

### DESCRIPTION OF REFERENCE NUMERALS

1: Flying Object
11: Envelope
12: Container
13: Suspension Ropes
22: Container
121: Main Body
122: Partition
221: Inner Main Body
222: Outer Main Body
223: Heat Insulating Material

1. A container for a flying object comprising:
a main body that is airtight and contains an object; and
a partition that divides a space in the main body into a first space and a second space;
wherein
the partition keeps the first space airtight, and
the main body has one or more holes that enable gas to flow between the second space and a space outside the main body.
